(19) United States
(12) Patent Application Publication
(10) Pub. No.: US 2024/0229252 A9
(43) Pub. Date: Jul. 11, 2024

(54) WATER ELECTROLYSIS CELL

(71) Applicant: TOYOTA JIDOSHA KABUSHIKI KAISHA, Toyota-shi (JP)

(72) Inventors: Hikaru HASEGAWA, Numazu-shi (JP); Kohsei YOSHIDA, Gotemba-shi (JP)

(73) Assignee: TOYOTA JIDOSHA KABUSHIKI KAISHA, Toyota-shi (JP)

(21) Appl. No.: 18/366,934

(22) Filed: Aug. 8, 2023

(30) Foreign Application Priority Data
Oct. 25, 2022 (JP) 2022-170344

(51) Int. Cl. C25B 1/04; C25B 11/032; C25B 11/053

(52) U.S. Cl. CPC C25B 1/04; C25B 11/032; C25B 11/053

(57) ABSTRACT

A water electrolysis cell includes an electrolyte membrane that is sandwiched between two catalyst layers, the two catalyst layers, two microporous layers each of which is disposed adjacent to a surface of each of the catalyst layers opposite to the electrolyte membrane side, two gas diffusion layers each of which is disposed adjacent to a surface of each of the microporous layers opposite to the catalyst layer side, and two separators each of which is disposed adjacent to a surface of each of the gas diffusion layers opposite to the microporous layer side. In the water electrolysis cell, an area of one of an oxygen electrode and a hydrogen electrode is smaller than an area of the other, and adhesion strength between each of the microporous layers and each of the catalyst layers is higher than that between each of the gas diffusion layers and each of the microporous layers.

### CROSS-REFERENCE TO RELATED APPLICATION

This application claims priority to Japanese Patent Application No. 2022-170344 filed on Oct. 25, 2022, incorporated herein by reference in its entirety.

### BACKGROUND

### 1. Technical Field

The present disclosure relates to a water electrolysis cell.

### 2. Description of Related Art

Various studies have been conducted on a water electrolysis device. For example, Japanese Unexamined Patent Application Publication No. 2017-203188 (JP 2017-203188 A) discloses a differential pressure type high-pressure water electrolysis device in which a portion where an electrolyte membrane and an insulating reinforcing member overlap along a lamination direction is bonded by an adhesive.

### SUMMARY

In order to increase the pressure of hydrogen generated by water electrolysis, there is a need to increase the pressure of a hydrogen electrode in the water electrolysis cell as compared with the pressure of an oxygen electrode in the water electrolysis cell. However, in the water electrolysis cell having a stepped structure at the end portion of an electrode portion, there is a problem that the electrolyte membrane bends due to the pressure difference between the hydrogen electrode and the oxygen electrode during the long-term operation of the water electrolysis cell, so that the electrolyte membrane easily breaks and leakage occurs.

The present disclosure has been made in view of the above circumstances, and an object of the present disclosure is to provide a water electrolysis cell capable of suppressing occurrence of breakage of the electrolyte membrane.

The present disclosure provides a water electrolysis cell that includes an electrolyte membrane, two catalyst layers, two microporous layers, two gas diffusion layers, and two separators, in which:
the electrolyte membrane is sandwiched between the two catalyst layers;
each of the microporous layers is disposed adjacent to a surface of each of the catalyst layers opposite to the electrolyte membrane side;
each of the gas diffusion layers is disposed adjacent to a surface of each of the microporous layers opposite to a side of each of the catalyst layers;
each of the separators is disposed adjacent to a surface of each of the gas diffusion layers opposite to a side of each of the microporous layers;
in the water electrolysis cell, an area of one of an oxygen electrode and a hydrogen electrode is smaller than an area of another of the oxygen electrode and the hydrogen electrode; and
adhesion strength between each of the microporous layers and each of the catalyst layers is higher than adhesion strength between each of the gas diffusion layers and each of the microporous layers.

In the present disclosure, a pore diameter of each of the gas diffusion layers is 10 μm or more and 100 μm or less.

The water electrolysis cell according to the present disclosure can suppress the occurrence of breakage of the electrolyte membrane.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic partial cross-sectional view illustrating an example of a part of a water electrolysis cell of the present disclosure.

### DETAILED DESCRIPTION OF EMBODIMENTS

Embodiments according to the present disclosure will be described below. It should be noted that matters other than those specifically mentioned in the present specification and necessary for the implementation of the present disclosure (for example, a general configuration and a manufacturing process of a water electrolysis cell that does not characterize the present disclosure) can be understood as design matters of a person skilled in the art based on the prior art in the field. The present disclosure may be carried out based on the content disclosed in the present specification and the common general technical knowledge in the field.

Also, the dimensional relationships (length, width, thickness, etc.) in the drawings do not reflect the actual dimensional relationships.

In the present specification, “to” indicating a numerical range is used in a sense including numerical values described before and after the numerical range as a lower limit value and an upper limit value.

Any combination of the upper limit value and the lower limit value in the numerical range can be adopted.

The present disclosure provides a water electrolysis cell that includes an electrolyte membrane, two catalyst layers, two microporous layers, two gas diffusion layers, and two separators, in which:
the electrolyte membrane is sandwiched between the two catalyst layers;
each of the microporous layers is disposed adjacent to a surface of each of the catalyst layers opposite to the electrolyte membrane side;
each of the gas diffusion layers is disposed adjacent to a surface of each of the microporous layers opposite to a side of each of the catalyst layers;
each of the separators is disposed adjacent to a surface of each of the gas diffusion layers opposite to a side of each of the microporous layers;
in the water electrolysis cell, an area of one of an oxygen electrode and a hydrogen electrode is smaller than an area of another of the oxygen electrode and the hydrogen electrode; and
adhesion strength between each of the microporous layers and each of the catalyst layers is higher than adhesion strength between each of the gas diffusion layers and each of the microporous layers.

The water electrolysis cell has an electrolyte membrane, two catalytic layers, two microporous layers (MPL), two gas-diffusion layers (GDL), and two separators. In the water electrolysis cell of the present disclosure, water supplied to an anode (oxygen electrode) is electrolyzed, oxygen is generated from the anode, and hydrogen is generated from the cathode (hydrogen electrode).
Anode: H₂O→2H⁺+1/2O₂+2e⁻
Cathode: 2H⁺+2e⁻→H₂

The water electrolysis cell includes an electrode portion.

The electrode portion includes an anode-side gas diffusion layer, an anode-side microporous layer, an anode catalyst layer, an electrolyte membrane, a cathode catalyst layer, a cathode-side microporous layer, and a cathode-side gas diffusion layer in this order.

In the present disclosure, the anode catalyst layer-electrolyte membrane-cathode catalyst layer assembly is referred to as a CCM.

The cathode (hydrogen electrode) includes a cathode catalyst layer, a cathode-side microporous layer, and a cathode-side gas diffusion layer.

The anode (oxygen electrode) includes an anode catalyst layer, an anode-side microporous layer, and an anode-side gas diffusion layer.

In the water electrolysis cell, one area of the oxygen electrode and the hydrogen electrode may be smaller than the other area, and the area of the oxygen electrode may be smaller than the area of the hydrogen electrode. As a result, the electrode portion of the water electrolysis cell has a stepped structure at the end portion in the surface direction.

Among the oxygen electrode and the hydrogen electrode, the catalyst layer, the microporous layer, and the gas diffusion layer of the electrode having a smaller area may all have a smaller area than that of the electrolyte membrane. Among the oxygen electrode and the hydrogen electrode, the catalyst layer, the microporous layer, and the gas diffusion layer of the electrode having a smaller area are not particularly limited as long as the area is smaller than that of the electrolyte membrane.

In the water electrolysis cell of the present disclosure, the pressure of the hydrogen electrode in the water electrolysis cell may be higher than the pressure of the oxygen electrode.

The cathode catalyst layer and the anode catalyst layer are collectively referred to as a catalyst layer.

The catalyst layer may include, for example, a catalyst metal that promotes an electrochemical reaction, an electrolyte with proton conductivity, a support with electron conductivity, and the like.

As the catalytic metal, for example, iridium (Ir), ruthenium (Ru), platinum (Pt), an alloy composed of Pt and another metal (for example, a Pt alloy obtained by mixing cobalt, nickel, and the like) can be used. The anode catalyst layer may use, for example, Ir, and Ru as catalyst metals, and the cathode catalyst layer may use, for example, Pt, and Pt alloys as catalyst metals.

The electrolyte may be fluorine-based resin or the like. As the fluorine-based resin, for example, Nafion solution or the like may be used.

The catalyst metal is supported on a carrier, and each catalyst layer may contain a mixture of a carrier supporting the catalyst metal (catalyst-supporting carrier) and an electrolyte. Examples of the carrier for supporting the catalyst metal include commercially available carbon materials such as carbon.

The electrolyte membrane is sandwiched between two catalyst layers. The two catalyst layers are one cathode catalyst layer and the other anode catalyst layer. The electrolyte membrane may be a solid polymer electrolyte membrane. Examples of the solid polymer electrolyte membrane include fluorine-based electrolyte membranes such as perfluorosulfonic acid thin films containing water, and hydrocarbon-based electrolyte membranes. As the electrolyte membrane, for example, a Nafion membrane (produced by DuPont) may be used.

The anode-side microporous layer and the cathode-side microporous layer are collectively referred to as a microporous layer.

Each of the anode-side microporous layer and the cathode-side microporous layer is disposed adjacent to a surface of each of the catalyst layers opposite to the electrolyte membrane side. That is, the anode-side microporous layer is disposed adjacent to the surface of the anode catalyst layer opposite to the electrolyte membrane side. The cathode-side microporous layer is disposed adjacent to a surface of the cathode catalyst layer opposite to the electrolyte membrane side.

The microporous layer may be a mixture of a water-repellent resin such as PTFE and a conductive material such as carbon black.

The microporous layer may have pores of 1 to several hundred μm.

The cathode-side gas diffusion layer and the anode-side gas diffusion layer are collectively referred to as a gas diffusion layer.

Each of the gas diffusion layers of the cathode-side gas diffusion layer and the anode-side gas diffusion layer is disposed adjacent to a surface of each of the microporous layers opposite to the catalyst layer. That is, the cathode-side gas diffusion layer is disposed adjacent to a surface of the cathode-side microporous layer opposite to the cathode catalyst layer. The anode-side gas diffusion layer is disposed adjacent to a surface of the anode-side microporous layer opposite to the anode catalyst layer.

The gas diffusion layer may be a gas permeable, that is, a conductive member having pores. Examples of the electroconductive member include porous carbon bodies such as carbon cloth and carbon paper, and porous metal bodies such as metal mesh and metal foam.

The anode separator and the cathode separator are collectively referred to as a separator. Each of the separators of the anode separator and the cathode separator is disposed adjacent to a surface of each gas diffusion layer opposite to the microporous layer side. That is, the cathode separator is disposed adjacent to a surface of the cathode-side gas diffusion layer opposite to the cathode-side microporous layer. The anode separator is disposed adjacent to a surface of the anode-side gas diffusion layer opposite to the anode-side microporous layer.

Two separators, an anode separator and a cathode separator, sandwich the resin frame and the electrode portion.

The separator may have holes such as a supply hole and a discharge hole for allowing a fluid such as reaction water, oxygen, hydrogen, and a cooling medium to flow in the stacking direction of the water electrolysis cell. As the reaction water and the cooling medium, water or the like can be used.

Examples of the supply hole include an anode supply hole, a cathode supply hole, and a cooling medium supply hole.

Examples of the discharge hole include an anode discharge hole, a cathode discharge hole, and a cooling medium discharge hole.

The separator may have a flow path of a reaction fluid such as reaction water, oxygen, or hydrogen on a surface in contact with the gas diffusion layer. In addition, the separator may have a flow path of a cooling medium for keeping the temperature of the water electrolysis cell constant on the surface opposite to the surface in contact with the gas diffusion layer. The anode separator may have a flow path of an anode fluid such as reactive water or oxygen on a surface in contact with the anode-side gas diffusion layer. In addition, the anode separator may have a flow path of a cooling medium for keeping the temperature of the water electrolysis cell constant on the surface opposite to the surface in contact with the anode-side gas diffusion layer.

The cathode separator may have a flow path of a cathode fluid such as hydrogen on a surface in contact with the cathode-side gas diffusion layer. In addition, the cathode separator may have a flow path of a cooling medium for keeping the temperature of the water electrolysis cell constant on the surface opposite to the surface in contact with the cathode-side gas diffusion layer.

The separator may be a gas-impermeable electroconductive member or the like. The conductive member may be, for example, dense carbon obtained by compressing a resin material such as a thermosetting resin, a thermoplastic resin, and a resin fiber, and a carbon material such as a carbon powder and a carbon fiber to make it gas impermeable, and a press-molded metal (for example, titanium, stainless steel, and the like) plate.

The shape of the separator may be a rectangle, a horizontally long hexagon, a horizontally long octagon, a circle, an oblong shape, and the like.

The water electrolysis cell may typically comprise a resin frame.

The resin frame is disposed on the outer periphery of the electrode portion and is disposed between the cathode separator and the anode separator.

The resin frame may have a framework portion, an opening portion, and a hole. The skeleton portion is a main portion of the resin frame connected to the electrode portion. The opening portion is a holding region of the electrode portion, and is a region penetrating a part of the skeleton portion for accommodating the electrode portion. The opening portion may be disposed at a position where the skeleton portion is disposed in the periphery (outer peripheral portion) of the electrode portion in the resin frame, and may be provided at the center of the resin frame.

The holes of the resin frame allow a fluid such as reaction water, oxygen, hydrogen, and a cooling medium to flow in the stacking direction of the water electrolysis cell. The holes in the resin frame may be aligned and arranged to communicate with the holes in the separator. The resin frame may include a frame-shaped core layer and two frame-shaped shell layers provided on both sides of the core layer, that is, a first shell layer and a second shell layer. The first shell layer and the second shell layer may be provided in a frame shape on both sides of the core layer, similarly to the core layer.

The core layer may be a structural member having a gas sealing property and an insulating property, and may be formed of a material whose structure does not change even under a temperature condition at the time of thermocompression bonding in the manufacturing process of the water electrolysis cell. Specifically, the material of the core-layer may be, for example, a resin such as polyethylene, polypropylene, polycarbonate (PC), polyphenylene sulfide (PPS), polyethylene terephthalate (PET), polyethylene naphthalate (PEN), polyamide (PA), polyimide (PI), polystyrene (PS), polyphenylene ether (PPE), polyether ether ketone (PEEK), cycloolefin, polyether sulfone (PES), polyphenyl sulfone (PPSU), liquid crystal polymer (LCP), or epoxy resin. The core-layer material may be a rubber material such as ethylene propylene diene rubber (EPDM), fluorine-based rubber, or silicone-based rubber.

The thickness of the core layer may be 5 μm or more, 20 μm or more, or 200μm or less, or 150μm or less, from the viewpoint of reducing the thickness of the water electrolysis cell, from the viewpoint of ensuring the insulating property.

The first shell layer and the second shell layer may have a high adherence property to other materials, have a property of softening under a temperature condition during thermocompression bonding and having a lower viscosity and melting point than the core layer, in order to adhere the core layer with the anode separator and the cathode separator and ensure a sealing performance. Specifically, the first shell layer and the second shell layer may be a thermoplastic resin such as a polyester-based thermoplastic resin and a modified olefin-based thermoplastic resin, or may be a thermosetting resin that is a modified epoxy resin.

The resin that constitutes the first shell layer and the resin that constitutes the second shell layer may be the same type of resin or different types of resin. By providing the shell layers on both sides of the core layer, it becomes easier to adhere the resin frame and the two separators by hot pressing.

The thickness of the shell layer of each of the first shell layer and the second shell layer may be 5 μm or more, 30 μm or more, or 100 μm or less, or 40 μm or less, from the viewpoint of reducing the thickness of the water electrolysis cell, from the viewpoint of ensuring adhesion.

In the resin frame, the first shell layer and the second shell layer may be provided only on the portions to be adhered to the anode separator and the cathode separator, respectively. The first shell layer provided on one side of the core layer may be adhered to the cathode separator. The second shell layer provided on the other side of the core layer may be adhered to the anode separator. Then, the resin frame may be sandwiched between the pair of separators.

In the present disclosure, the adhesive strength between each microporous layer and each catalyst layer is higher than the adhesive strength between each gas diffusion layer and each microporous layer. The adhesive strength between each microporous layer and each catalyst layer may be 1.4 times or more higher than the adhesive strength between each gas diffusion layer and each microporous layer.

In the present disclosure, the adhesion strength between the anode-side microporous layer and the anode catalyst layer may be the same as the adhesion strength between the cathode-side microporous layer and the cathode catalyst layer.

In the present disclosure, the adhesion strength between the anode-side gas diffusion layer and the anode-side microporous layer may be the same as the adhesion strength between the cathode-side gas diffusion layer and the cathode-side microporous layer.

Conventionally, the adhesion strength between the microporous layer and the catalyst layer is equal to or less than the adhesion strength between the gas diffusion layer and the microporous layer.

On the other hand, in the present disclosure, the adhesion strength between the microporous layer and the catalyst layer is set to be higher than the adhesion strength between the gas diffusion layer and the microporous layer. Thus, in the water electrolysis cell, the catalytic layer is reinforced by the microporous layer (MPL), and thus the electrolyte membrane can be prevented from bending.

In order to achieve the above-described adhesive strength, the pore diameter of GDL may be 100 micrometers or less from the viewpoint of suppressing MPL from penetrating into GDL during MPL forming and reducing the adhesive strength between MPL and GDL. From the viewpoint of discharging hydrogen, the pore diameter may be 10 μm or more.

The coating solution of MPL at the time of forming MPL may be an aqueous solution from the viewpoint of suppressing MPL from being impregnated in GDL having hydrophobicity and reducing the adhesive strength between MPL and GDL.

The aqueous solution may be a mixed solution of water-soluble polytetrafluoroethylene (PTFE) and a dispersant.

Examples of the dispersant include a surfactant having a perfluoroalkyl group manufactured by AGC, a non-fluorinated dispersant manufactured by Sekisui Chemical Co., Ltd., Rheocor (registered trademark) manufactured by LION, a fluororesin dispersant “Futergent” manufactured by Neos Co., Ltd., a D-111 manufactured by Daikin Industries, Ltd., and a N1310 (trade name) manufactured by Nippon Emulsifier Co., Ltd.

In the present disclosure, the adhesion strength between the electrolyte membrane and each catalyst layer may be higher than the adhesion strength between each gas diffusion layer and each microporous layer from the viewpoint of facilitating the migration of protons.

In the present disclosure, the adhesive strength between the electrolyte membrane and each catalyst layer may be the same as the adhesive strength between each microporous layer and each catalyst layer.

In the present disclosure, the adhesion strength between the electrolyte membrane and the anode catalyst layer may be the same as the adhesion strength between the electrolyte membrane and the cathode catalyst layer.

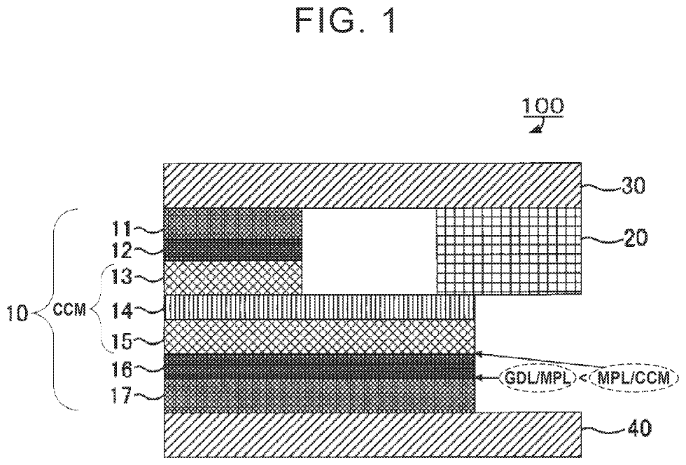

FIG. 1 is a schematic partial cross-sectional view illustrating an example of a part of a water electrolysis cell of the present disclosure.

As illustrated in FIG. 1, the water electrolysis cell 100 of the present disclosure includes an electrode portion 10, a resin frame 20, an anode separator 30 and a cathode separator 40 that sandwich the electrode portion.

The electrode portion 10 includes an anode-side gas diffusion layer 11, an anode-side microporous layer 12, an anode catalyst layer 13, an electrolyte membrane 14, a cathode catalyst layer 15, a cathode-side microporous layer 16, and a cathode-side gas diffusion layer 17 in this order.

The areas of the anode-side gas diffusion layer 11, the anode-side microporous layer 12, and the anode catalyst layer 13 constituting the oxygen electrode are smaller than the areas of the electrolyte membrane 14, the cathode catalyst layer 15, the cathode-side microporous layer 16, and the cathode-side gas diffusion layer 17 constituting the hydrogen electrode. As a result, the electrode portion 10 of the water electrolysis cell 100 has a stepped structure at the end portion in the surface direction.

A portion of the resin frame 20 may be disposed on an end portion of the electrolyte membrane 14. Although not shown, the resin frame 20 is disposed so as to surround the electrode portion 10 in a plan view.

In the water electrolysis cell 100, the adhesive strength between each of the microporous layers 12 and 16 and each of the catalyst layers 13 and 17 and the adhesive strength between the electrolyte membrane 14 and each of the catalyst layers 13 and 17 are designed to be higher than the adhesive strength between each of the gas diffusion layers 11 and 15 and each of the microporous layers 12 and 16. Accordingly, in the water electrolysis cell 100 in which the gas pressure on the hydrogen electrode side is high, since each of the catalyst layers 13 and 17 has a structure reinforced by each of the microporous layers 12 and 16, even if the pressure of the hydrogen electrode in the water electrolysis cell 100 is higher than the pressure of the oxygen electrode, the electrolyte membrane 14 can be prevented from bending and breaking.

### Example 1

A water electrolysis cell having an electrode portion whose adhesion strength between each microporous layer, each catalyst layer, and the electrolyte membrane is 1.4 times higher than the adhesion strength between each gas diffusion layer and each microporous layer was prepared.

The pressure of the hydrogen electrode of the water electrolysis cell was set to 0.9MPaabs, and the pressure of the oxygen electrode was set to 0.1MPaabs, and the time until the leakage occurred was measured. The results are shown in Table 1.

### Comparative Example 1

A water electrolysis cell having an electrode portion in which the adhesion strength between each microporous layer, each catalyst layer, and the electrolyte membrane was lower than the adhesion strength between each gas diffusion layer and each microporous layer was prepared, and the time until leakage occurred was measured for the water electrolysis cell in the same manner as in Example 1. The results are shown in Table 1.

TABLE 1

| | Bond strength | Time to leak |
|---|---|---|
| Comparative | GDL/MPL > MPL/CCM | Less than 1 hr |
| Example 1 | | |
| Example 1 | GDL/MPL < MPL/CCM | Do not occur after 100 hr |

In the water electrolysis cell of Example 1, it was confirmed that no leakage occurred even after 100 hours or more. Therefore, according to the configuration of the present disclosure, even if the pressure of the hydrogen electrode in the water electrolysis cell is higher than the pressure of the oxygen electrode, the electrolyte membrane can be prevented from bending and breaking, and the occurrence of leakage can be reduced.

What is claimed is:

1. A water electrolysis cell comprising
an electrolyte membrane, two catalyst layers, two microporous layers, two gas diffusion layers, and two separators, wherein:
the electrolyte membrane is sandwiched between the two catalyst layers;
each of the microporous layers is disposed adjacent to a surface of each of the catalyst layers opposite to the electrolyte membrane side;
each of the gas diffusion layers is disposed adjacent to a surface of each of the microporous layers opposite to a side of each of the catalyst layers;
each of the separators is disposed adjacent to a surface of each of the gas diffusion layers opposite to a side of each of the microporous layers;
in the water electrolysis cell, an area of one of an oxygen electrode and a hydrogen electrode is smaller than an area of another of the oxygen electrode and the hydrogen electrode; and
adhesion strength between each of the microporous layers and each of the catalyst layers is higher than adhesion strength between each of the gas diffusion layers and each of the microporous layers.

2. The water electrolysis cell according to claim 1, wherein a pore diameter of each of the gas diffusion layers is 10 μm or more and 100 μm or less.
